(19) United States
(12) Patent Application Publication
(10) Pub. No.: US 2023/0210198 A1
(43) Pub. Date: Jul. 6, 2023

(54) SELECTIVELY WEIGHTED AND GRIPPED FABRIC

(71) Applicant: Kathryn Furgal, San Diego, CA (US)

(72) Inventor: Kathryn Furgal, San Diego, CA (US)

(21) Appl. No.: 17/567,059

(22) Filed: Dec. 31, 2021

(51) Int. Cl. A41D 13/00

(52) U.S. Cl. CPC A41D 13/0015; A41D 2600/10

(57) ABSTRACT

An improvement in the field of fabrics, wherein the fabrics provide improvements such as weighted regions (20) and grip locations (40). Currently, wearable weights are very limited in many ways such as, but not limited to, placement of the weights, fit of wearable weight to the user's body, sustained placement of the wearable weight during athletic use. The fabric (10) provides a solution to this problem by allowing the integrating the weights and other features into the material of any article of clothing or similar fabric object. The fabric (10) affords the user the comfort, flexible and other advantages typical of athletic clothing along with added benefits of weight training. Further, the grip locations (40) provide surface friction for athletic applications such as, but not limited to, fitness workouts and yoga. The principal use of the fabric (10) is as an article of clothing.

### RELATED APPLICATIONS

This application claims the benefit of priority to U.S. Provisional Application No. 63/133,243 entitled “SELECTIVELY WEIGHTED FABRIC” filed Jan. 1, 2021, the entire contents of which are hereby incorporated by reference.

### TECHNICAL FIELD

The present disclosure relates to fabrics and, more specifically, fabrics integrated with weighted regions, silicone grips and other components.

### BACKGROUND

The amount of time a person or athlete can train is at least one determining factor in the physical performance of said person or athlete. Such individuals will break up fitness activities into multiple routines throughout the day or extend a routine to increase their duration of exercise. To further increase training during the day some individuals will wear weights during other physical activities or regular activities.

Relatedly, athletic shoes will often have a specific designed level of grip based on the athletic activity involved.

However, these products are limited in many ways, such as, but not limited to, location and positioning of the weights when worn. Additionally, grip integrated into articles of clothing besides athletic shoes are limited. This disclosure allows an optimized placement of weighted material and gripping material in a new innovative manner without the drawbacks seen in products available today.

### SUMMARY

Aspects and advantages of the invention will be set forth in part in the following description, or may be obvious from the description, or may be learned through practice of the invention.

The present disclosure is directed to fabric (10), wherein the fabric (10) can be integrated or incorporated into various products or goods made from fabric or similar material such as, but not limited to, articles of clothing.

In general, one innovative aspect of the subject matter described in this specification can be embodied in fabric (10) that includes a first surface area (12), second surface area (14), at least one weighted region (20) and at least one non-weighted region (30).

In some embodiments, the fabric (10) includes a first surface area (12), second surface area (14), at least one weighted region (20), at least one non-weighted region (30), and the fabric (10) is incorporated into an article of clothing, wherein the first surface area (12) is the external surface of the article of clothing and the second surface area (14) is the internal surface of the article of clothing.

In some embodiments, the fabric (10) includes a first surface area (12), second surface area (14), at least one weighted region (20), at least one non-weighted region (30) and the fabric (10) is incorporated into an article of clothing, wherein the first surface area (12) is the external surface of the article of clothing and the second surface area (14) is the internal surface of the article of clothing, wherein the article of clothing is an athletic shirt.

In some embodiments, the fabric (10) includes a first surface area (12), second surface area (14), at least one weighted region (20), at least one non-weighted region (30) and the fabric (10) is incorporated into an article of clothing, wherein the first surface area (12) is the external surface of the article of clothing and the second surface area (14) is the internal surface of the article of clothing, wherein the article of clothing is an athletic shirt, wherein one or more of the at least one weighted regions (20) is located at the elbow region of the athletic shirt.

In some embodiments, the fabric (10) includes a first surface area (12), second surface area (14), at least one weighted region (20), at least one non-weighted region (30) and the fabric (10) is incorporated into an article of clothing, wherein the first surface area (12) is the external surface of the article of clothing and the second surface area (14) is the internal surface of the article of clothing, wherein the article of clothing is an athletic shirt, wherein one or more of the at least one weighted regions (20) is located at the wrist region of the athletic shirt.

In some embodiments, the fabric (10) includes a first surface area (12), second surface area (14), at least one weighted region (20), at least one non-weighted region (30) and the fabric (10) is incorporated into an article of clothing, wherein the first surface area (12) is the external surface of the article of clothing and the second surface area (14) is the internal surface of the article of clothing, wherein the article of clothing is athletic pants.

In some embodiments, the fabric (10) includes a first surface area (12), second surface area (14), at least one weighted region (20), at least one non-weighted region (30) and the fabric (10) is incorporated into an article of clothing, wherein the first surface area (12) is the external surface of the article of clothing and the second surface area (14) is the internal surface of the article of clothing, wherein the article of clothing is athletic pants, wherein one or more of the at least one weighted regions (20) is located at the thigh region of the athletic pants.

In some embodiments, the fabric (10) includes a first surface area (12), second surface area (14), at least one weighted region (20), at least one non-weighted region (30) and the fabric (10) is incorporated into an article of clothing, wherein the first surface area (12) is the external surface of the article of clothing and the second surface area (14) is the internal surface of the article of clothing, wherein the article of clothing is athletic pants, wherein one or more of the at least one weighted regions (20) is located at the ankle region of the athletic pants.

In some embodiments, the fabric (10) includes a first surface area (12), second surface area (14), at least one weighted region (20), at least one non-weighted region (30), and at least one grip location (40).

In some embodiments, the fabric (10) includes a first surface area (12), second surface area (14), at least one weighted region (20), at least one non-weighted region (30), and at least one grip location (40) wherein each grip location (40) is embodied as one or more lines.

In some embodiments, the fabric (10) includes a first surface area (12), second surface area (14), at least one weighted region (20), at least one non-weighted region (30), and at least one grip location (40) wherein the at least one grip location (40) is a silicon grip.

In some embodiments, the fabric (10) includes a first surface area (12), second surface area (14), at least one weighted region (20), at least one non-weighted region (30), and at least one grip location (40) wherein the at least one grip location (40) is disposed on the first surface area (12).

In some embodiments, the fabric (10) includes a first surface area (12), second surface area (14), at least one weighted region (20), at least one non-weighted region (30), and the at least one weighted region (20) and non-weighted region (30) are made of the same material.

In some embodiments, the fabric (10) includes a first surface area (12), second surface area (14), at least one weighted region (20), at least one non-weighted region (30), and the at least one weighted region (20) and non-weighted region (30) are made of different materials.

In some embodiments, the fabric (10) includes a first surface area (12), second surface area (14), at least one weighted region (20), at least one non-weighted region (30), and the at least one weighted region (20) is disposed on the first surface area (12) and second surface area (14).

In some embodiments, the fabric (10) includes a first surface area (12), second surface area (14), at least one weighted region (20), at least one non-weighted region (30), and the at least one weighted region (20) is disposed on the first surface area (12).

In some embodiments, the fabric (10) includes a first surface area (12), second surface area (14), at least one weighted region (20), at least one non-weighted region (30), and the at least one weighted region (20) is disposed on the second surface area (14).

In some embodiments, the fabric (10) includes a first surface area (12), second surface area (14), at least one weighted region (20), at least one non-weighted region (30), and the at least one non weighted region (30) is disposed on the first surface area (12).

In some embodiments, the fabric (10) includes a first surface area (12), second surface area (14), at least one weighted region (20), at least one non-weighted region (30), and the at least one non weighted region (30) is disposed on the second surface area (14).

In some embodiments, the fabric (10) includes a first surface area (12), second surface area (14), at least one weighted region (20), at least one non-weighted region (30), and the at least one non weighted region (30) is disposed on the first surface area (12) and the second surface area (14).

In some embodiments, the fabric (10) includes a first surface area (12), second surface area (14), at least one weighted region (20), at least one non-weighted region (30), and the mass of the at least one weighted region (20) is greater than the mass of the at least one non-weighted region (30).

In some embodiments, the fabric (10) includes a first surface area (12), second surface area (14), at least one weighted region (20), at least one non-weighted region (30), and the at least one weighted region (20) and the at least one non-weighted region (30) are positioned in a layering manner.

In some embodiments, the fabric (10) includes a first surface area (12), second surface area (14), at least one weighted region (20), at least one non-weighted region (30), and the at least one weighted region (20) and the at least one non-weighted region (30) are positioned in a manner creating a pattern.

The present disclosure is also directed to a fabric (10) comprising of a first surface area (12), a second surface area (14), at least one non-weighted region (30) and at least one grip location (40).

The present disclosure is also directed to a method of using a fabric (10) as a component of an article of clothing, wherein the fabric (10) comprises of a first surface area (12), a second surface area (14), at least one weighted region (20) and at least one non-weighted region (30).

In some embodiments, the fabric (10) includes a first surface area (12), a second surface area (14), one or more weighted regions (20) and one or more non-weighted regions (30).

In some embodiments, the fabric (10) is an athletic shirt, wherein one or more of the weighted region (20) are located at the elbow region of the athletic shirt, and wherein one or more of the weighted region (20) are located at the wrist region of the athletic shirt.

In some embodiments, the fabric (10) is athletic pants, wherein one or more of the weighted regions (20) are located at the thigh region of the athletic pants, and wherein one or more of the weighted regions (20) are located at the ankle region of the athletic pants.

In some embodiments, the fabric (10) is an article of clothing, wherein all of the weighted regions (20) are positioned on the fabric (10) so when the fabric (10) is worn all of the weighted regions (20) stay positioned on the anterior body surface of the user.

In some embodiments, the fabric (10) includes weighted regions (20) wherein all of the weighted regions are shaped like a disc.

In some embodiments, the fabric (10) includes weighted regions (20) wherein all of the weighted regions are made of tungsten.

In some embodiments, the fabric (10) includes at least one of the weighted regions (20) shaped like a disc, wherein at least one of the weighted regions comprises of tungsten, high gravity compound and rubber, further wherein the tungsten is encapsulated by the high gravity compound, and further wherein the tungsten encapsulated by high gravity compound is further encapsulated with rubber.

In some embodiments, the fabric (10) are embodied as athletic pants, wherein all of the weighted regions (20) are positioned on the fabric (10) so when the fabric (10) is worn all of the weighted regions (20) stay positioned at the knees and on the anterior body surface of the user.

In some embodiments, the method includes using a fabric (10) as a component of an article of clothing, wherein the fabric (10) comprises of a first surface area (12), a second surface area (14), at least one weighted region (20) and at least one non-weighted region (30) wherein the fabric (10) further comprises of at least one grip location (40).

### BRIEF DESCRIPTION OF THE FIGURES

A full and enabling disclosure of the present invention, including the best mode thereof, directed to one of ordinary skill in the art, is set forth in the specification, which makes reference to the appended drawings in, which:

FIG. 1 is a front perspective view of an exemplary embodiment of the fabric (10) wherein the weighted region (20) is layered between one continuous piece of non-weighted region (30);

FIG. 2 is a top perspective view of an exemplary embodiment of the fabric (10) wherein the weighted region (20) is in the shape of a “v” and is disposed on top of the first surface (12) of the fabric (10);

FIG. 3 is an orthogonal front view of an exemplary embodiment of the fabric (10) as an article of clothing wherein the weighted regions (20) are positioned in a pattern;

FIG. 4 is an orthogonal left view of an exemplary embodiment of the fabric (10) as an article of clothing wherein the weighted regions (20) are positioned in a pattern;

FIG. 5 is the embodiment shown in FIG. 4 with a sectional closeup of the weighted region (20) showing an embodiment of an internal chamber of the weighted region (20);

FIG. 6 is an orthogonal front view of an exemplary embodiment of the fabric (10) as an article of clothing wherein the weighted regions (20) are positioned in a ring pattern;

FIG. 7 is an orthogonal left view of an exemplary embodiment of the fabric (10) as an article of clothing wherein the weighted regions (20) are positioned in a ring pattern;

FIG. 8 is the embodiment shown in FIG. 7 with a sectional closeup of the weighted region (20) showing an embodiment of an internal chamber of the weighted region (20);

FIG. 9 is an orthogonal right view of an exemplary embodiment of the fabric (10) wherein the weighted region (20) is layered between the non-weighted region (30) and the weighted region (20) makes up part of the first surface area (12) at specific locations;

FIG. 10 is an orthogonal back view of an exemplary embodiment of the fabric (10) wherein the weighted region (20) and non-weighted regions (30) are layered and the order of the layering changes at different portions of the fabric (10);

FIG. 11 is an orthogonal left view of an exemplary embodiment of the fabric (10) wherein the weighted region (20) and non-weighted regions (30) are layered and arranged in a pattern wherein the pattern changes at different locations in the fabric (10); and,

FIG. 12 is an orthogonal front view of an exemplary embodiment of the fabric (10) wherein the weighted region (20) and non-weighted regions (30) are positioned in a layering manner. Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: A, B, or C” is intended to cover A, B, C, A-B, A-C, B-C, and A-B-C, as well as any combination with multiples of the same element (e.g., A-A A-A-A, A-A-B, A-A-C, A-B-B, A-C-C, B-B, B-B-B, B B-C, C-C, and C-C-C or any other ordering of A, B, and C).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

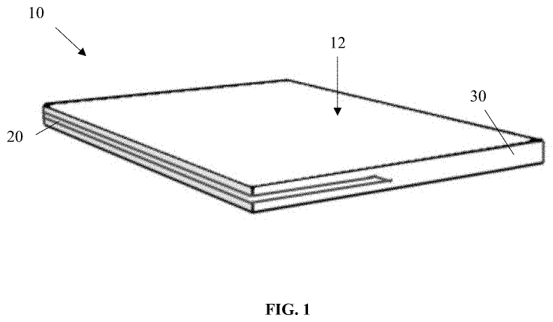

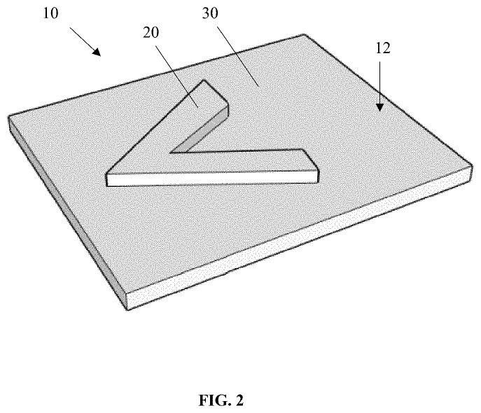

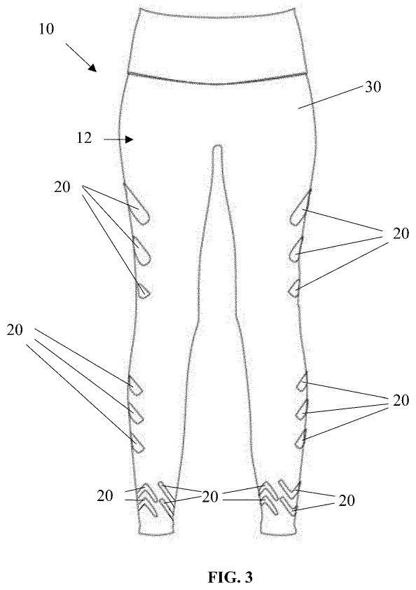

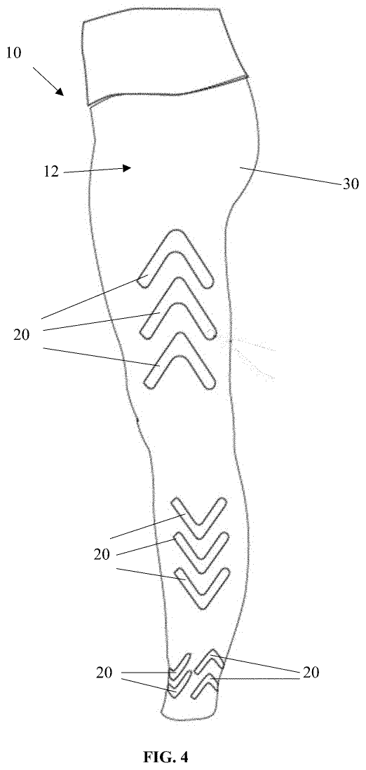

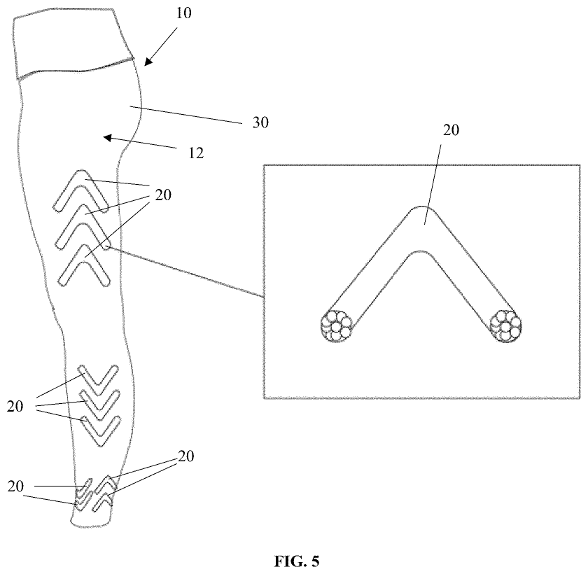

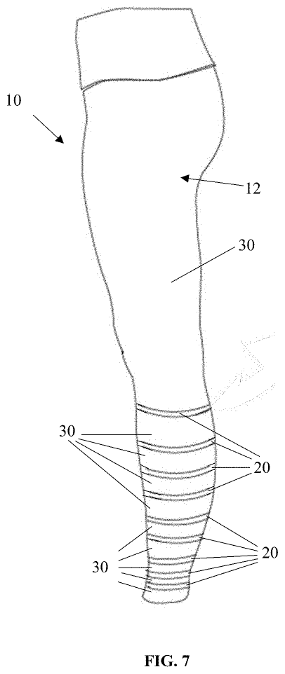

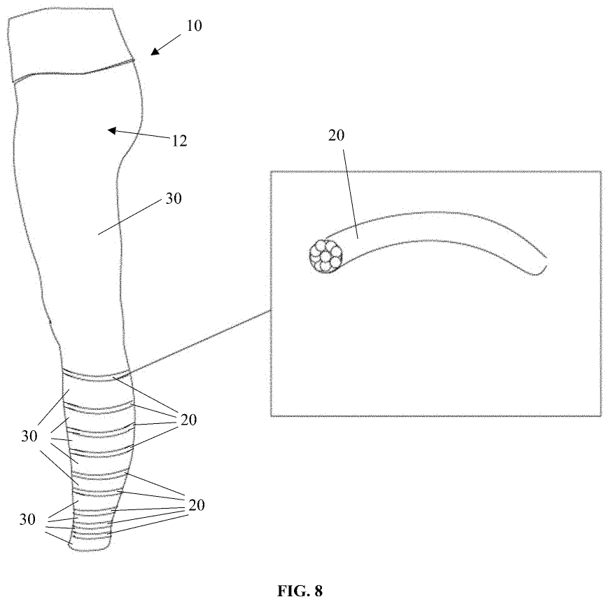

The fabric (10) is made up of at least one region. As shown throughout the figures, a region refers to a portion of the fabric (10) such as an area or a volume of any definite size or shape. In some embodiments, the fabric (10) is made up of at least two types of regions, a weighted region (20) and a non-weighted region (30). Similar to the embodiments in FIGS. 1 and 2, the fabric (10) can be limited to one weighted region (20). Similar to the embodiments in FIGS. 3-8, the fabric (10) can include more than one weighted region (20). Similar to the embodiments in FIGS. 1 and 2, the fabric (10) can be limited to one non-weighted region (30). Similar to the embodiments in FIGS. 3-8, the fabric (10) can include more than one non-weighted region (30).

Similar to the embodiments in FIGS. 3-8 an article of clothing can be made of the fabric (10). Various articles of clothing can be made of the fabric (10). Some non-exhaustive examples of the possibilities of articles of clothing that can made of the fabric (10) include shirts, athletic shirts, T shirts, tank top, under clothes, underwear, pants, shorts, gym shorts, socks, athletic socks, athletic pants, shoes, sneakers, boots, hoodies, sweatshirts, business suit, jeans, apron, baldric, basque, bathing suit, bathrobe, bikini, blouse, body stocking, bodysuit, boubou, bib and brace, overalls, bustier, suspenders, chaps, coat, dolman, gown, night gown, gambeson, gloves, haik, jacket, jersey, pajamas, rompers, sash, leggings, yoga pants, swimming trunks, swimsuit, smock, dress, underskirt and other articles of clothing. Further the fabric (10) can be limited to a portion, section, or part of an article of clothing. An illustrative example would be an article of clothing, specifically, a shirt, wherein the sleeves of the shirt are made of the fabric (10).

The fabric (10), weighted regions (20) and non-weighted regions (30) can be made of various materials including man made textile fibers and natural textile fibers. For example, the fabric (10), weighted regions (20) and non-weighted regions (30) can be made of alpaca, angora, camel, cashmere, wool, chiengora, llama, mohair, qiviut, vicuna, yak, byssus, silk, cotton, coir, kapok, banana, flax/linen, hemp, jute, kenaf, ramie, sugarcane, abaca, pina, raffia, sisal, acetate, bamboo, lyocell, modal, rayon, acrylic, kevlar, nomex, nylon, polyester, spandex.

The weighted regions (20) can be made of additional compounds such as one or more types of metals and/or plastics. The weighted regions (20) can be made of additional compounds such as high gravity compounds (HGCs), high density polymers, and/or a polymer with a weighted component. HGCs are compounds that have the weight and physical properties of metal with the design and production advantages of injection molded plastics.

In some embodiments, the weighted regions are made up of one or more types of weighted metals. In some embodiments, the weighted regions are made up of one or more types of weighted metals and plastics. In some embodiments, one or more of the weighted regions (20) are made of tungsten. In some embodiments, one or more of the weighted regions (20) are made of high gravity compounds. In some embodiments, one or more of the weighted regions (20) are made of rubber. In some embodiments, one or more of the weighted regions (20) are made of tungsten and high gravity compounds. In some embodiments, one or more of the weighted regions (20) are made of tungsten and rubber. In some embodiments, one or more of the weighted regions (20) are made up of tungsten, high gravity compounds and rubber.

The weighted regions (20) can be made of various materials to provide the desired weight. In some embodiments, the weighted regions (20) will be made of various materials and/or designs to ensure that the weighted regions (20) are a plurality of weights. The weighted regions (20) can be plurality of weights wherein one group of the weighted regions (20) are one specific weight and a second group of the weighted regions (20) are different specific weight. There can be further groups of weighted regions (20) at different weights. Furthermore, the weighted regions (20) can be set to a plurality and/or a random disbursement of weights between a set range, such as, but not limited to 100 to 1000 grams.

In some embodiments, the non-weighted region (30) can be made of the same material as the fabric (10). In some embodiments, the non-weighted region (30) can be made of the same as the weighted region (20). In some embodiments, the non-weighted region (30) can be made of the same material as the fabric (10) and the weighted region (20). In some embodiments, the non-weighted region (30) is made up of one material. In some embodiments, the non-weighted region (30) is made up of multiple different materials such as, but not limited to, a composite material.

The weighted region (20) is made of various materials. In some embodiments, the weighted region (20) can be made of the same material as the fabric (10). In some embodiments, the weighted region (20) is made up of the same material as the non-weighted region (30) and the weighted region (20) has an increase in density. In some embodiments, the weighted region (20) is made up of the same material as the non-weighted region (30) and the weighted region (20) has an increase in thickness. In some embodiments, the weighted region (20) is made up of one material. In some embodiments, the weighted region (20) is made up of multiple different materials such as, but not limited to, a composite material.

The weighted region (20) can be made up of a shredded material. The weight region (2) can be made up of a flaky material. The weight region (2) can be made up of one or more rods. The weight region (2) can be made up of one or more cylinders. The weight region (2) can be made up of one or more beads. The weight region (2) can be made up of one or more spheres.

The weighted region (20) can have an internal chamber wherein the internal chamber contains a shredded material. The weighted region (20) can have an internal chamber wherein the internal chamber contains a shredded material, wherein the shredded material provides the weighted region (20) additional weight and/or density.

The weighted region (20) can have an internal chamber wherein the internal chamber contains a flaky material. The weighted region (20) can have an internal chamber wherein the internal chamber contains a flaky material, wherein the flaky material provides the weighted region (20) additional weight and/or density.

The weighted region (20) can have an internal chamber wherein the internal chamber contains one or more rods. The weighted region (20) can have an internal chamber wherein the internal chamber contains one or more rods, wherein the one or more rods provides the weighted region (20) additional weight and/or density.

The weighted region (20) can have an internal chamber wherein the internal chamber contains one or more cylinders. The weighted region (20) can have an internal chamber wherein the internal chamber contains one or more cylinders, wherein the one or more cylinders provides the weighted region (20) additional weight and/or density.

The weighted region (20) can have an internal chamber wherein the internal chamber contains one or more beads. The weighted region (20) can have an internal chamber wherein the internal chamber contains one or more beads, wherein the one or more beads provides the weighted region (20) additional weight and/or density.

The weighted region (20) can have an internal chamber wherein the internal chamber contains one or more spheres. The weighted region (20) can have an internal chamber wherein the internal chamber contains one or more beads, wherein the one or more spheres provides the weighted region (20) additional weight and/or density.

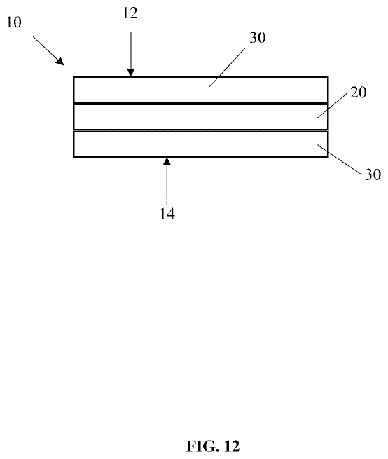

The regions of the fabric (10) can be positioned and oriented in various manners. Also, the regions of the fabric (10) can be positioned in a layering manner. The fabric (10) can be generally described as having a first surface area (12) and a second surface area (14). Similar to the embodiment in FIG. 1, in some embodiments the layering of regions is only implemented at limited areas, portions, segments, sides, and/or parts of the fabric (10). Similar to the embodiment in FIG. 12, in some embodiments, the layering of regions is implemented throughout all areas, portions, segments, sides, and/or parts of the fabric (10).

Similar to FIGS. 3-8, when the fabric (10) is an article of clothing, the first surface area (12) is the more distal side or the external side of the article of clothing. When the fabric (10) is part of an article of clothing, the first surface area (12) is part of the more distal side or part of the external side of that part of the article of clothing. When the fabric (10) is an article of clothing, the second surface area (14) is the more proximal side or the internal side of the article of clothing. When the fabric (10) is part of an article of clothing, the second surface area (14) is part of the more proximal side or part of the internal side of the article of clothing.

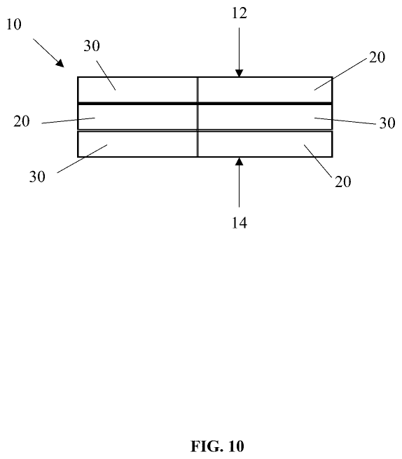

Similar to the embodiment in FIG. 12 and in some embodiments, the order of the layered regions is the same throughout all portions of the fabric (10) having layered regions. Similar to the embodiment in FIG. 10 and in some embodiments, the order of the layered regions changes at different areas, portions, segments, sides, and/or parts of the fabric (10).

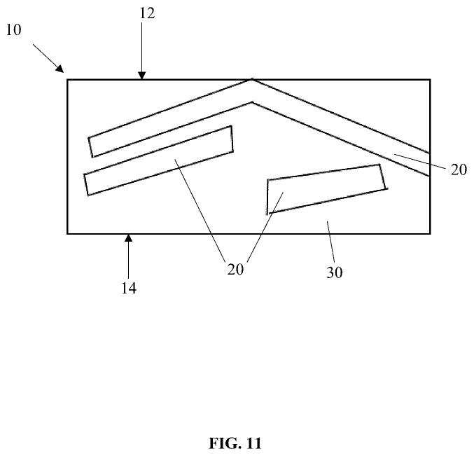

Similar to the embodiment in FIG. 12 and in some embodiments, the pattern of the layered regions is the same throughout all portions of the fabric (10) having layered regions. Similar to the embodiment in FIG. 11 and in some embodiments, the pattern of the layered regions changes at different areas, portions, segments, sides, and/or parts of the fabric (10).

In some embodiments, the fabric (10) includes one or more layers of non-weighted regions (30). In some embodiments, the fabric (10) includes one or more layers of weighted regions (20). In some embodiments, the fabric (10) includes one or more layers of both weighted regions (20) and non-weighted regions (30).

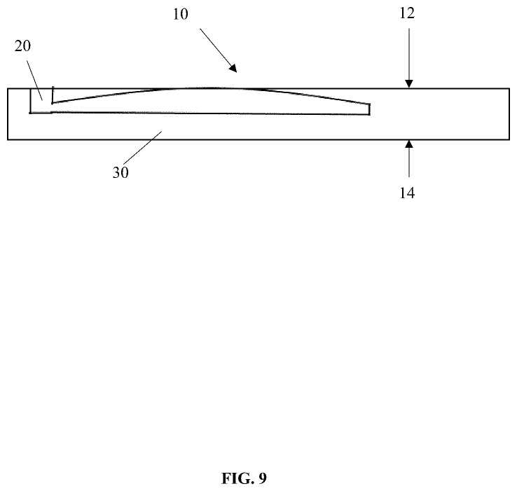

Similar to FIGS. 9 and 11, and in some embodiments, one or more weighted regions (20) and one or more non-weighted regions (30) are layered in a manner, wherein part or all of one or more weighted regions (20) are exposed at the first surface area (12), the second surface area (14) or both surface areas. In some embodiments, one or more weighted regions (20) and one or more non-weighted regions (30) are layered in a manner, wherein part or all of one or more non weighted regions (30) are exposed at the first surface area (12), the second surface area (14) or both surface areas. In some embodiments, one or more weighted regions (20) and one or more non-weighted regions (30) are layered in a manner, wherein part or all of one or more of the weighted regions (20) and one or more of the non-weighted regions (30) are exposed at the first surface area (12), the second surface area (14) or both surface areas.

In some embodiments, the fabric (10) includes one continuous non-weighted region (30). In some embodiments, the fabric (10) includes one continuous non-weighted region (30) and one weighted region (20), wherein the weighted region (20) is positioned on the one continuous non-weighted region (30). In some embodiments, the fabric (10) includes one continuous non-weighted region (30) and one weighted region (20), wherein the weighted region (20) is positioned adjacent to the one continuous non-weighted region (30). In some embodiments, the fabric (10) includes one continuous non-weighted region (30) and more than one weighted region (20), wherein at least one of the weighted regions (20) is positioned on the one continuous non-weighted region (30). In some embodiments, the fabric (10) includes one continuous non-weighted region (30) and more than one weighted region (20), wherein at least one of the weighted regions (20) is positioned adjacent to the one continuous non-weighted region (30). In some embodiments, the fabric (10) includes one continuous non-weighted region (30) and at least one weighted region (20), wherein at least one of the at least one weighted regions (20) is positioned both on and adjacent to the one continuous non-weighted region (30).

In some embodiments, the fabric (10) includes multiple non-weighted regions (30). In some embodiments, the fabric (10) includes multiple non-weighted regions (30) and at least one weighted region (20), wherein at least one of the at least one weighted regions (20) is positioned adjacent to one or more of the non-weighted regions (30).

In some embodiments, the fabric (10) includes multiple non-weighted regions (30) and at least one weighted region (20), wherein at least one of the weighted regions (20) is positioned on one or more of the non-weighted regions (30).

In some embodiments, the fabric (10) includes multiple non-weighted regions (30) and at least one weighted region (20), wherein at least one of the at least one weighted regions (20) is position both on one or more non-weighted regions (30) and adjacent to a separate non-weighted region (30).

In some embodiments, the fabric (10) includes multiple non-weighted regions (30) and one weighted region (20), wherein the weighted region (20) is positioned on one or more of the non weighted regions (30). In some embodiments, the fabric (10) includes multiple non-weighted regions (30) and multiple weighted regions (20) wherein one or more of the weighted regions (20) are place on the non-weighted regions (30) and the remaining weighted regions (20) are place adjacent to one or more of the non-weighted regions (30).

In some embodiments, the fabric (10) includes one continuous weighted region (20) and multiple non-weighted regions (30). In some embodiments, the fabric (10) includes one continuous weighted region (20) and multiple non-weighted regions (30), wherein the multiple non-weighted regions (30) are placed on, near, and/or adjacent to the weighted region (20).

In some embodiments, the fabric (10) includes multiple weighted regions (20) and multiple non-weighted regions (30), wherein the multiple non-weighted regions (30) are placed on, near, and/or adjacent to one or more of the weighted regions (20).

In some embodiments, one or more of the weighted regions (20) are non-removable. In some embodiments, one or more of the weighted regions (20) are machine washable. In some embodiments, one or more of the weighted regions (20) are removable. In some embodiments, one or more of the weighted regions (20) are attachable and removable. In some embodiments, wherein one or more of the weighted regions (20) are attachable and removable, the weighted regions (20) are attachable and removable with a hook-and-loop fastener. Hook-and-pile fasteners or also referred to as “touch fasteners” include two lineal fabric strips which are attached to the opposing surfaces to be fastened. The first lineal fabric strip features tiny hooks, the second lineal fabric strip features smaller loops. In some embodiments, wherein one or more of the weight regions (20) are attachable and removable, the weighted regions (20) are attachable and removable with magnets positioned to the opposing surfaces to be fastened. All other fastening means in the field of fabrics and clothing could be implemented for the feature of a removable and re-attachable weighted region (20). In some embodiments wherein the weighted regions (20) are removable and re-attachable weighted regions (20), the weighted regions (20) have a designated portion or part that is gripped, touched, pocket, or otherwise made contact with by the user when removing and reattaching.

In some embodiments one or more of the weighted regions (20) is embodied as a particular shape. In some embodiments, all the weighted regions (20) are embodied as a particular shape. In some embodiments one or more of the weighted regions (20) is embodied as a plurality of shapes. In some embodiments, all the weighted regions (20) are embodied as a plurality of shapes. These shapes could include but are not limited to, nonagon, octagon, heptagon, hexagon, octagon, pentagon, oval, arrow, circle, semi-circle, decagon, ring, trefoil, star, heart, crescent, rectangle, kite, quadrilateral, rhombus, triangle, scalene triangle, right triangle, parallelogram, square, trapezoid, oval, and other polygons. The weighted regions (20) can be embodied as lettering, roman numerals, and similar symbols, including, but not limited to, exclamation point, lemniscate, and equal sign.

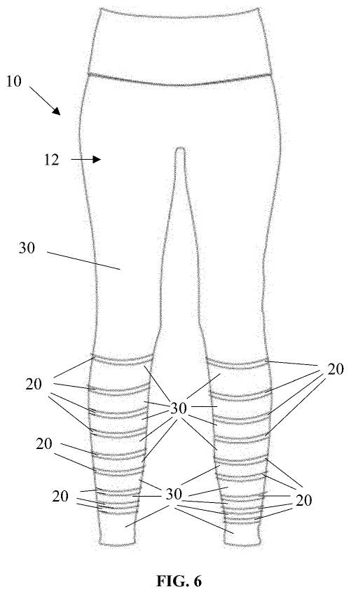

The weighted regions (20) can be embodied tube, rod, cylinder, or similar shape. In some embodiments, all of the weighted regions (20) are embodied as a tube, rod, cylinder, or similar shape. Similar to the embodiments in FIGS. 6-8, in some embodiments one or more of the weighted regions (20) are embodied as a tube, rod, cylinder, or similar shape and wrap completely an appendage or part of the user's body wherein the two ends of the tube, rod, cylinder, or similar shape make contact thereby making a ring. The edges of the weighted regions (20) can be rounded, hard edge, or seamlessly matched the bordering materials and/or other components of the fabric (10) and/or weighted regions (20).

In some embodiments, one or more of the weighted regions (20) are shaped like a disk. In some embodiments, one or more of the weighted regions (20) are shaped like a disk and made of tungsten. In some embodiments, one or more of the weighted regions (20) are shaped like a disk and made of high gravity compounds. In some embodiments, one or more of the weighted regions (20) are shaped like a disk and made of rubber. In some embodiments, one or more of the weighted regions (20) are shaped like a disk and made of tungsten and high gravity compound wherein tungsten is encapsulated by the high gravity compound. In some embodiments, one or more of the weighted regions (20) are shaped like a disk and made of tungsten and rubber wherein tungsten is encapsulated by the rubber. In some embodiments, one or more of the weighted regions (20) are shaped like a disk and made of tungsten, high gravity compound and rubber, wherein the tungsten is encapsulated by the high gravity compound and rubber.

In some embodiments, one or more weighted regions (20) are positioned in a manner so as a whole the plurality of weighted regions (20) make a pattern or shape. For example, in FIG. 3 the weighted regions (20) are in the shape of a “v’ and placed in a grouping manner of multiple v's.

In some embodiments, when the fabric (10) is embodied as an article of clothing or embodied as part of an article of clothing, one or more of the weighted regions (20) and non-weighted regions (30) can be disposed a position that is based on the anticipated location of the user's body when the article of clothing is worn. For example, in some embodiments one or more weighted regions are positioned at the ankle region and/or knee region of pants. In some embodiments one or more weighted regions are positioned at the wrist region and/or elbow region.

When using anatomical terminology, anterior is used to describe the front or direction toward the front of the body. For example, the toes are anterior to the foot. Furthermore, the anterior body surface is the surface of the body that faces forward.

Due to the characteristics of the invention is an article of clothing, when the one or more weighted regions (20) are limited to the anterior body surface in regards to that article of clothing, the one or more weighted regions (20) produce dramatically less drag and discomfort in comparison to having the one or more weighted regions (20) positioned on or near the posterior body surface.

In some embodiments, wherein the fabric (10) is an article of clothing the one or more weighted regions (20) are positioned on the article of clothing so when worn the one or more weighted regions (20) are positioned to be on or near the anterior body surface of the wearer. In some embodiments, wherein the fabric (10) is an article of clothing the one or more weighted regions (20) are positioned on the anterior body surface of the article of clothing, specifically on anterior body surface region of the article of clothing that aligns with the top of one or both of the knees of the user.

In some embodiments, the fabric (10) further includes at least one grip location (40). In some embodiments, the grip location (40) is designed to increase the amount of static friction thereby preventing slipping or sliding. In some embodiments, the grip location (40) is designed to increase the amount of kinetic friction thereby increasing the amount of energy needed for an object to slide across the grip location (40). In some embodiments, the grip location (40) is designed to increase the amount of static and kinetic friction.

In some embodiments, the grip locations (40) are located on the first surface area (12) of the fabric (10). In some embodiments, the grip locations (40) are located on the second surface area (14) of the fabric (10). The grip locations (40) can be in the shape of lines. The grip locations (40) can be in the shape of rectangles. The grip locations (40) can be positioned in a grouping manner. The grip locations (40) can be positioned in a grouping manner, wherein the grip locations (40) are group around areas that commonly make contact such as, but not limited to, the legs, forearms, back, and hands. The grip locations (40) can be positioned on top of one or more weighted regions (20). The grip locations (40) can be positioned on top of one or more non-weighted regions (30). The grip locations (40) can be positioned on top of one or more weighted regions (20) and one or more non-weighted regions (30).

The grip locations (40) can be positioned in an organized pattern or randomized in position on the first surface (12) of the fabric (10). The grip locations (40) can be positioned in both a symmetrical and asymmetrical manner. The grip locations (40) can be positioned in both a symmetrical and asymmetrical manner in relation to the first surface (12) of the fabric (10).

When the fabric (10) is incorporated into an article of clothing or incorporated into a part of an article of clothing, the grip locations (40) can be positioned in both a symmetrical and asymmetrical manner in relation to the article of clothing.

When the fabric (10) is incorporated into an article of clothing or incorporated into a part of an article of clothing, the grip locations (40) can be positioned at or near designated parts of the article of clothing. For example, the grip locations (40) can be located at areas of the pants configured for the user to place their knees and/or ankles when the pants are worn by the user. In another example the grip locations (40) can be located at areas of the shirt configured for the user to place their wrists and/or elbows when the shirt is worn by the user.

The grip locations (40) can be made of various materials such as, but not limited to, silicon, natural, rubber, synthetic rubber, plastic, fluoropolymer elastomer, polyurethane, nitrile, thermoplastic elastomers, polymers, or a combination of these.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A fabric (10) comprising of a first surface area (12), a second surface area (14), one or more weighted regions (20) and one or more non-weighted regions (30).

2. The fabric (10) of claim 1, wherein the fabric (10) is incorporated into an article of clothing, wherein the first surface area (12) is the external surface of the article of clothing and the second surface area (14) is the internal surface of the article of clothing.

3. The fabric (10) of claim 2, wherein the article of clothing is athletic shirt, wherein one or more of the weighted region (20) are located at the elbow region of the athletic shirt, and wherein one or more of the weighted region (20) are located at the wrist region of the athletic shirt.

4. The fabric (10) of claim 2, wherein the article of clothing is athletic pants, further wherein one or more of the weighted regions (20) are located at the thigh region of the athletic pants, and wherein one or more of the weighted regions (20) are located at the ankle region of the athletic pants.

5. The fabric (10) of claim 2, wherein all of the weighted regions (20) are positioned on the fabric (10) so when the fabric (10) is worn all of the weighted regions (20) stay positioned on the anterior body surface of the user.

6. The fabric (10) of claim 1, wherein the fabric (10) further comprises one or more grip locations (40).

7. The fabric (10) of claim 9, wherein each of the grip locations (40) are embodied as one or more lines.

8. The fabric (10) of claim 9, wherein the one grip locations (40) are silicon grip and wherein all of the grip locations are disposed on the first surface area (12).

9. The fabric (10) of claim 2, wherein the article of clothing is athletic pants, further wherein all of the weighted regions (20) are positioned on the fabric (10) so when the fabric (10) is worn all of the weighted regions (20) stay positioned at the knees and on the anterior body surface of the user.

10. The fabric (10) of claim 1, wherein the weighted regions (20) and the non-weighted regions (30) are made of different materials.

11. The fabric (10) of claim 1, wherein at least one weighted region (20) is disposed on the first surface area (12) and at least one weighted region (20) is disposed on the second surface area (14).

12. The fabric (10) of claim 1, wherein at least one non-weighted region (30) is disposed on the first surface area (12) and at least one non-weighted region is disposed on the second surface area (14).

13. The fabric (10) of claim 1, wherein the mass of the at least one weighted region (20) is greater than the mass of the at least one non-weighted region (30).

14. The fabric (10) of claim 1, wherein one or more weighted regions (20) and one or more non-weighted regions (30) are positioned in a layering manner.

15. The fabric (10) of claim 1, wherein one or more weighted regions (20) and one or more non-weighted regions (30) are positioned in a manner creating a pattern.

16. The fabric (10) of claim 1, wherein all of the weighted regions are in the shape of a disc.

17. The fabric (10) of claim 1, wherein all of the weighted regions are made of tungsten.

18. The fabric (10) of claim 1, wherein at least one of the weighted regions (20) are shaped like a disc, wherein at least one of the weighted regions comprises of tungsten, high gravity compound and rubber, further wherein the tungsten is encapsulated by the high gravity compound, and further wherein the tungsten encapsulated by high gravity compound is further encapsulated with rubber.

19. A fabric (10) comprising of a first surface area (12), a second surface area (14), one or more non-weighted regions (30) and one or more grip locations (40).

20. A method of using a fabric (10) as a component of an article of clothing, wherein the fabric (10) comprising of a first surface area (12), a second surface area (14), at least one weighted region (20) and at least one non-weighted region (30).
